(19) United States
(12) Patent Application Publication
(10) Pub. No.: US 2005/0239496 A1
(43) Pub. Date: Oct. 27, 2005

(54) Mobile terminal with wired and wireless network interfaces

(75) Inventor: Dany Sylvain, Gatineau (CA)

Correspondence Address: WITHROW & TERRANOVA, P.L.L.C., P.O. BOX 1287, CARY, NC, 27512, US

(73) Assignee: NORTEL NETWORKS LIMITED, St. Laurent (CA)

(21) Appl. No.: 10/824,662

(22) Filed: Apr. 14, 2004

(51) Int. Cl. H04Q 7/20

(52) U.S. Cl. 455/552.1; 455/557

(57) ABSTRACT

The present invention provides a mobile terminal capable of supporting both wired and local wireless interfaces to support communications. When a connection to a network via the wired interface is available, the mobile terminal will establish sessions via the wired interface. If communications via the wired interface are not possible, communications are established via the local wireless interface or an optional cellular interface. If existing communications via the wired interface are no longer possible, a new session may be established via the local wireless interface to continue the prior communication. In case of such an event, the communications will be associated with a particular ID, which is used when establishing the new session such that the original communication may continue over the new session.

### FIELD OF THE INVENTION

The present invention relates to communications, and in particular to providing a mobile terminal having both wired and wireless network interfaces.

### BACKGROUND OF THE INVENTION

Given the increasing popularity and availability of devices supporting local wireless communications, such as those implementing Bluetooth and 802.11 communication standards, cellular telephones are being configured to support both cellular and local wireless communications. These multimode mobile terminals are able to support communication sessions, including voice-based calls, through cellular or local wireless networks, assuming service is available. The cellular networks use traditional cellular technologies, including Code Division Multiple Access, Time Division Multiple Access, Orthogonal Frequency Division Multiplexing, and other multiple access standards that generally support communications between a local base station and a mobile terminal over an extended range, which is typically greater than that provided by the local wireless networks.

The local wireless communications are not intended to replace cellular communications, but to further enhance and extend the coverage for wireless communications. For example, local wireless networks may be deployed throughout an office or other building complex where cellular coverage is difficult. There is hope that the local wireless and cellular networks will complement one another and provide greater functionality to users. Local wireless networks are generally connected to or otherwise supported by a local area network. Being based on a wireless technology, local wireless networks are more susceptible to intermittent performance variations based on coverage, interference, and capacity. In general, the capacity of a local wireless network is significantly less than that provided by an Ethernet-based local area network. In an effort to alleviate local wireless traffic, there is a need for an effective way to allow mobile terminals to communicate directly over the local area network, without using local wireless communications, when access to the local area network is available to the user of the mobile terminal. In addition to alleviating the burden on the local area network, the user of the mobile terminal will enjoy a more stable and higher performance network connection. There is a further need to direct communications to the appropriate wired or wireless interface in an automated fashion, depending on the mobile terminal's network connection.

### SUMMARY OF THE INVENTION

The present invention provides a mobile terminal capable of supporting both wired and local wireless interfaces to support communications. When a connection to a network via the wired interface is available, the mobile terminal will establish sessions via the wired interface. If communications via the wired interface are not possible, communications are established via the local wireless interface or an optional cellular interface. If existing communications via the wired interface are no longer possible, a new session may be established via the local wireless interface to continue the prior communication. In case of such an event, the communications will be associated with a particular ID, which is used when establishing the new session such that the original communication may continue over the new session.

In one embodiment, the wired interface is configured to connect to an associated communication network via a docking station, which is capable of receiving the mobile terminal. When the mobile terminal is docked in the docking station, communications through the wired interface are provided. When the mobile terminal is not docked in the docking station, communications may be established via the local wireless interface or an optional cellular interface. The docking station may include a user interface through which the user may provide input indicating that the mobile terminal will be removed from the docking station. If a communication session is established, the signal provided to the mobile terminal from the docking station can trigger the mobile terminal to establish a new session via the local wireless interface to continue the communications.

Separate addresses are associated with the mobile terminal when using the wired and local wireless interfaces in one embodiment. Prior to initiating communications through either type of interface, the mobile terminal may register the appropriate IP address with a service node, which may participate in controlling or establishing communication sessions. Further, the mobile terminal may be configured to obtain these IP addresses from an IP address server, such as when using Dynamic Host Control Protocol.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a communication environment according to one embodiment of the present invention.

FIG. 2 is an exemplary communication flow diagram according to one embodiment of the present invention.

FIG. 3 is a block representation of a docking station and a mobile terminal according to a first embodiment of the present invention.

FIG. 4 is a block representation of a docking station and a mobile terminal according to a second embodiment of the present invention.

FIG. 5 is a block representation of a service node according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

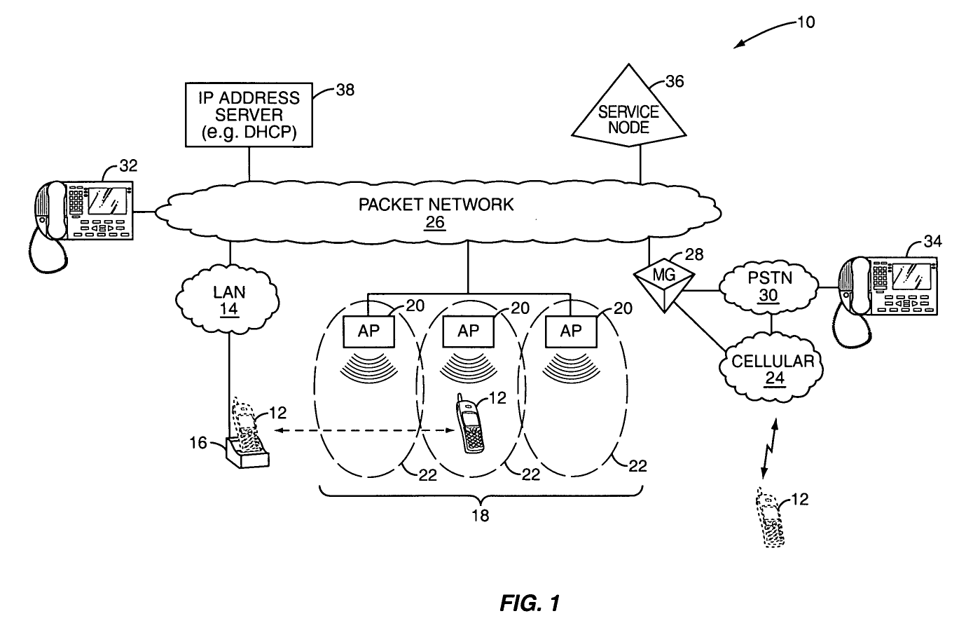

Turning now to FIG. 1, a communication network 10 is illustrated according to one embodiment of the present invention, and is configured to support communications with a mobile terminal 12 through both wired and local wireless network interfaces. For the wired interface, the mobile terminal 12 will connect to a local area network (LAN) 14 directly or indirectly via an appropriate docking station 16. The local area network 14 may take the form of a traditional Ethernet-based network, cable network or digital subscriber line (DSL) network. For local wireless communications, the mobile terminal 12 may communicate using an appropriate local wireless communication standard with a local wireless network 18, which is formed by one or more local wireless access points 20. Each access point 20 will provide a limited local wireless zone 22 through which communications with the access point 20 are possible.

In addition to supporting the wired and local wireless communications, the mobile terminal 12 may be configured to support cellular communications through a cellular network 24. Accordingly, the mobile terminal 12 may support wired, local wireless, and cellular communications in one embodiment of the present invention. The LAN 14 may be part of or coupled to a packet network 26, which is directly or indirectly coupled to the local wireless network 18, such that the mobile terminal 12 may facilitate communication sessions over the packet network 26 via the wired or local wireless connections, depending on the location of the mobile terminal 12. The cellular network 24 may be coupled to the packet network 26 via a media gateway 28, which will support interworking between the packet-based communications of the packet network 26 and the circuit-switched connections associated with the cellular network 24. In a similar fashion, a Public Switched Telephone Network (PSTN) 30 may be coupled to the packet network 26 via the media gateway 28, and may also be coupled to the cellular network 24.

In the communication environment 10, the mobile terminal 12 may facilitate communication sessions over the packet network 26, the PSTN 30, and the cellular network 24, via wired, local wireless, or cellular communications. To illustrate some of the flexibility, from the wired, local wireless, or cellular connections, communication sessions may be established with a packet-based telephony terminal 32 as well as a circuit-switched telephony terminal 34. For packet-based communication sessions, and in particular those originating through the wired or local wireless connections, a service node 36 may be involved to facilitate call signaling between the mobile terminal 12 and the media gateway 28 or other packet device. Further, the service node 36 may facilitate various types of call forwarding and routing, depending on the location of the mobile terminal 12. For the present invention, the service node 36 acts as a proxy for the mobile terminal 12, which will register its location with the service node 36 to support both wired and local wireless communications, as will be discussed in greater detail below. For both wired and local wireless communications, the mobile terminal 12 may need to be provided with an Internet Protocol (IP) address. If allocation of an IP address is required, an IP address server 38, such as a Dynamic Host Control Protocol (DHCP) server may be provided to allocate an IP address to the mobile terminal 12 when the mobile terminal 12 is available for wired or local wireless communications.

In operation, the mobile terminal 12 will either have or obtain IP addresses for both wired and local wireless communications. These different IP addresses will be used to facilitate communications with the mobile terminal, depending on location. As noted, the mobile terminal 12 will register with the service node 36 upon connecting to the LAN 14, being docked in the docking station 16, or coming within communication range of one of the access points 20 of the local wireless network 18. For purposes of discussion, assume the wired connection is through the docking station 16 and the local wireless connection is facilitated by one of the access points 20. Further assume that the local wireless network 18 provides coverage over an area in which the docking station 16 is located. Although the placement of the docking station 16 does not have to fall within the local wireless network 18, this configuration illustrates one of the significant benefits of the present invention.

When the mobile terminal 12 is docked in the docking station 16, the mobile terminal 12 will register its LAN-based IP address as its primary contact with the service node 36. When undocked, the mobile terminal 12 will register its local wireless based IP address with the service node 36. The service node 36 will then remove the LAN-based IP address as the primary contact and use the local wireless IP address as the primary contact. Accordingly, the service node 36 can direct incoming calls to the mobile terminal 12 through the appropriate wired or local wireless interface, as well as support outgoing calls with the appropriate IP address for the given wired or local wireless connection. When the docking status changes during an active communication session or just prior to a docking status change, when the user signals to the mobile terminal 12 or docking station 16 she is about to undock the mobile terminal 12, the mobile terminal 12 will take the necessary steps to register with the service node 36 as well as initiate a new communication session with the same party, to effectively continue communications. The new request may contain the same communication ID, as well as provide the new IP address for the mobile terminal 12 through the new network connection.

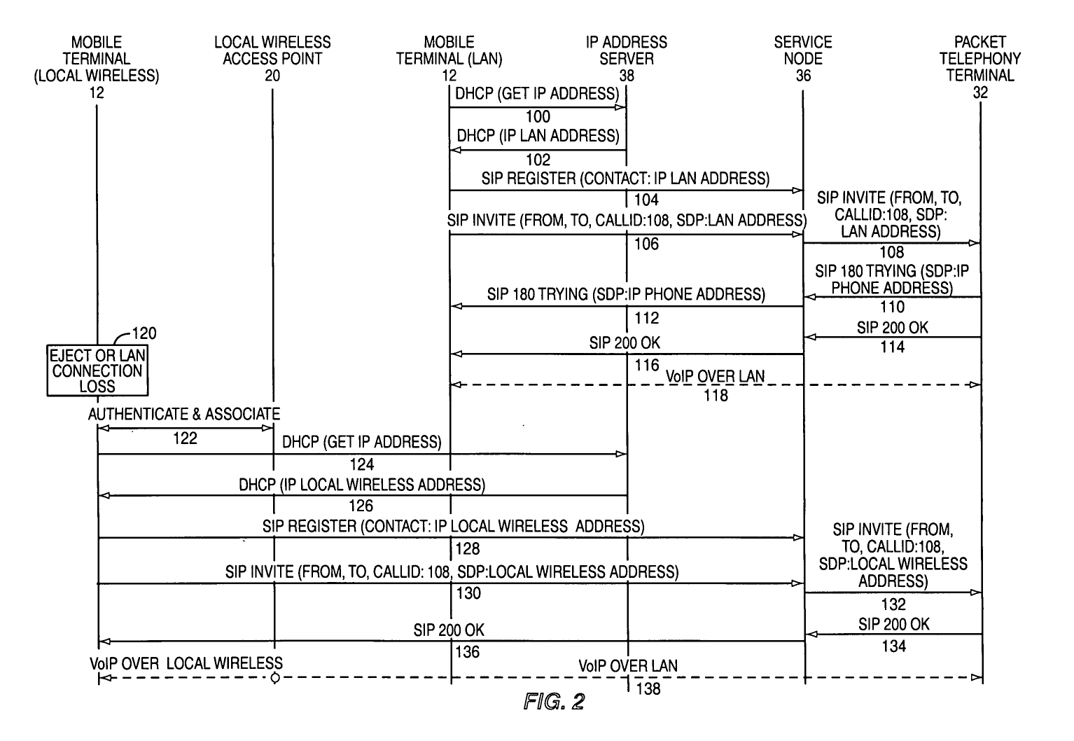

Turning now to FIG. 2, a detailed communication flow diagram is provided, wherein the mobile terminal 12 initiates a call to the packet telephony terminal 32 via a wired connection through the LAN 14. Once the communication session with the packet telephony terminal 32 is established, the mobile terminal 12 is removed from the docking station 16 and initiates another communication session with the packet telephony terminal 32 in an effort to continue communications. In this example, the communications between the mobile terminal 12 and the packet telephony terminal 32 consist of a voice-based call, although those skilled in the art will recognize that any type of media session may be supported by the concepts of the present invention. Further assume that the IP address server 38 is a DHCP server, wherein a new IP address is allocated to the mobile terminal 12 upon being connected to the docking station 16 or coming within communication range of an access point 20. The mobile terminal 12 is preferably configured to detect the presence of the docking station 16 when the mobile terminal 12 is physically placed in the docking station 16 or placed sufficiently proximate to the docking station 16 to enable communications. In one embodiment, no docking station 16 is required, and the LAN 14 is accessed by connecting the LAN cable directly into the mobile terminal 12.

The call flow begins when the mobile terminal 12 is placed in the docking station 16 and sends a DHCP request to obtain an IP address to the IP address server 38 (step 100). The IP address server 38 will respond by providing an IP LAN address (step 102). Upon receiving the IP LAN address, the mobile terminal 12 will register with the service node 36 by sending a SIP Register message providing the IP LAN address as the contact information for the mobile terminal 12 (step 104). In this embodiment, the Session Initiation Protocol (SIP) is used for establishing and controlling sessions between the various packet-based entities, including the mobile terminal 12, service node 36, and packet telephony terminal 32.

To initiate a communication session with the packet telephony terminal 32, the mobile terminal 12 will send a SIP Invite message toward the packet telephony terminal 32 (step 106). Assuming the service node 36 acts as a SIP proxy for the mobile terminal 12, the SIP Invite message will be received by the service node 36 and then forwarded to the packet telephony terminal 32 (step 108). The SIP Invite message will identify the call with a call identification (CALLID) number (108), as well as provide Session Data Protocol (SDP) information including the IP LAN address for the mobile terminal 12 and any information identifying the originating (FROM) and terminating (TO) information.

In response to receiving the SIP Invite message, the packet telephony terminal 32 will send a SIP 180 Trying message toward the mobile terminal 12 (step 110). Again, the service node 36 will receive a SIP 180 Trying message from the packet telephony terminal 32 and forward it to the mobile terminal 12 (step 112). In the SDP information in the SIP 180 Trying message, the packet telephony terminal 32 will provide its address, IP PHONE ADDRESS. At this point, the packet telephony terminal 32 will ring until it is answered. Upon being answered, a SIP 2000K message is sent toward the mobile terminal 12 and received by the service node 36 (step 114), which will forward the SIP 2000K message to the mobile terminal 12 (step 116). At this point, the mobile terminal 12 and the packet telephony terminal 32 have the requisite information to send and receive packets from each other to support the communication session, which is associated with CALLID: 108. Thus, a voice over IP (VoIP) session is established over the LAN 14 and packet network 26 (step 118).

Assume that during the communication session, the mobile terminal 12 is removed from the docking station 16, and thus the wired connection over the LAN 14 is lost (step 120). At this point, the mobile terminal 12 will recognize that the wired connection is lost and that a local wireless connection is available. As such, the mobile terminal 12 and the appropriate local wireless access point 20 will communicate with one another to authenticate communications and provide an appropriate association therebetween in traditional fashion (step 122). Alternatively, to provide a smoother transition, the mobile terminal 12 or the docking station 16 may have an eject button that the user presses before removing the device from the docking station 16. When the eject button is pressed, the mobile terminal 12 may actively prepare the wireless interface prior to ejection and therefore allow minimum disruption at the transition from wireline to wireless connectivity. Assuming the mobile terminal 12 is not assigned a static IP address for local wireless communications, the mobile terminal 12 will send a DHCP request to the IP address server 38 to obtain an IP address for local wireless communications (step 124). The IP address server 38 will provide the mobile terminal 12 with an appropriate address, IP LOCAL WIRELESS ADDRESS (step 126). Notably, communications with the IP address server 38 are supported via the local wireless network 18 and the packet network 26.

The mobile terminal 12 will then register with the service node 36 using the IP LOCAL WIRELESS ADDRESS (step 128). The mobile terminal will immediately send a SIP Invite message toward the packet telephony terminal 32 to establish a new communication session to support the call (step 130). The SIP Invite message will include the originating (FROM) and terminating (TO) information, as well as the original call identification (CALLID: 108), and will provide the new IP LOCAL WIRELESS ADDRESS, which must be used for communications with the mobile terminal 12. The SIP Invite message is received by the service node 36 and forwarded to the packet telephony terminal 32 (step 132). The packet telephony terminal 32 will respond with a SIP 2000K message (step 134), acknowledging the change of IP address to use for the session. The SIP 2000K message is received by the service node 36 and forwarded to the mobile terminal 12 through the local wireless interface (step 136). At this point, a voice over IP session is established between the mobile terminal 12 and the packet telephony terminal 32 (step 138). Notably, local wireless communications are used to facilitate the session between the mobile terminal 12 and the local wireless access point 20.

If the mobile terminal 12 is placed back in the docking station 16 or otherwise connected to the LAN 14, the mobile terminal 16 can obtain another IP LAN address from the IP address server 38, register the IP LAN address with the service node 36, and initiate a new communication session through which to continue the communications. To initiate the new session, a SIP Invite message may be sent with the same CALLID (108). As such, the communications may transition back through the LAN 14 from the local wireless network 18.

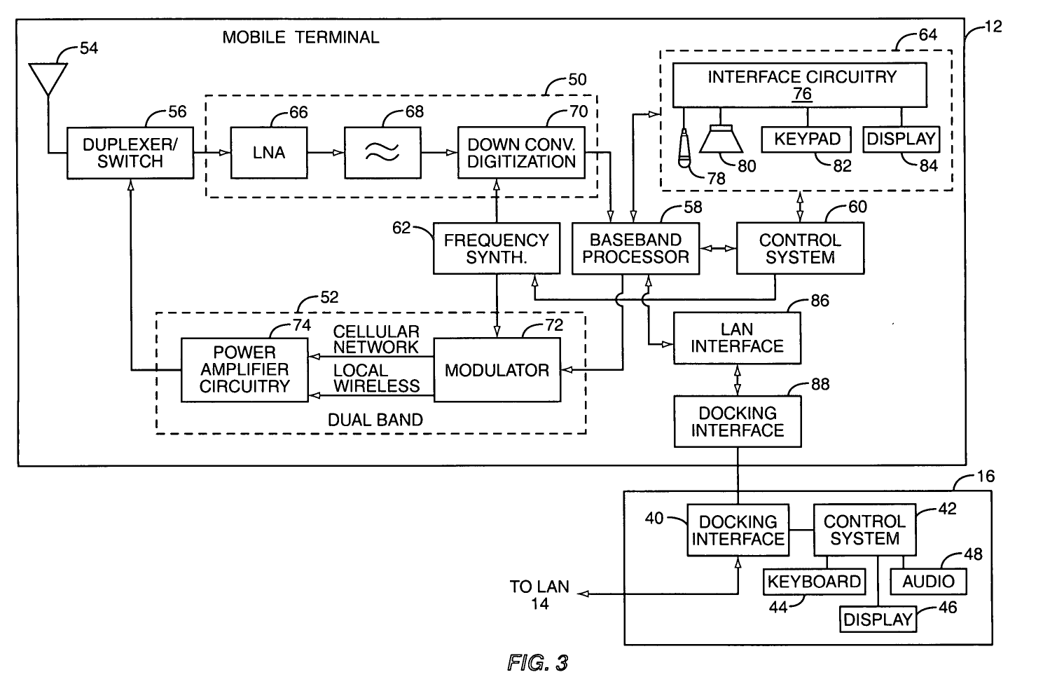

Turning now to FIG. 3, block representations of a mobile terminal 12 and a compatible docking station 16 are illustrated. At the heart of the docking station 16 lies a docking interface 40 to which the mobile terminal 12 will engage when docked in the docking station 16. The docking interface 40 will facilitate bidirectional communications between the LAN 14, or other network, and the mobile terminal 12. The docking interface 40 may also provide power to the mobile terminal 12 for operation as well as for recharging batteries. Depending on the sophistication of the docking station 16, a control system 42 may be provided in association with a user interface for the docking station that may include a keyboard 44, display 46, and audio circuitry 48, which may include a microphone and speaker (not shown). The user interface and the control system 42 may interact with the docking interface 40 to facilitate communication sessions over the LAN 14. Thus, the docking station 16 may function as a standalone telephony terminal. Alternatively, the control system 42 may interact with the mobile terminal 12 such that various functions of the mobile terminal 12 may be provided at the docking station 16, such as facilitating a speakerphone function. The docking station 16 may include additional ports and a hub to facilitate connections with multiple devices.

In one embodiment, the control system 42 is configured to detect when a certain button or key on the keyboard is pressed to alert the mobile terminal 12 of an impending removal of the mobile terminal 12 from the docking station 16. Thus, the mobile terminal 12 can take the necessary steps to prepare for local wireless communications, as described above. Further, the docking station 16 may cooperate with the mobile terminal 12 to facilitate or otherwise assist in registration as well as the setup and establishment of communication sessions.

The basic architecture of the mobile terminal 12 may include a receiver front end 50, a radio frequency transmitter section 52, an antenna 54, a duplexer or switch 56, a baseband processor 58, a control system 60, a frequency synthesizer 62, and a user interface 64. The receiver front end 50 receives information bearing radio frequency signals from one or more remote transmitters provided by a base station. A low noise amplifier 66 amplifies the signal. A filter circuit 68 minimizes broadband interference in the received signal, while downconversion and digitization circuitry 70 downconverts the filtered, received signal to an intermediate or baseband frequency signal, which is then digitized into one or more digital streams. The receiver front end 50 typically uses one or more mixing frequencies generated by the frequency synthesizer 62. The baseband processor 58 processes the digitized received signal to extract the information or data bits conveyed in the received signal. This processing typically comprises demodulation, decoding, and error correction operations. As such, the baseband processor 58 is generally implemented in one or more digital signal processors (DSPs).

On the transmit side, the baseband processor 58 receives digitized data, which may represent voice, data, or control information, from the control system 60, which it encodes for transmission. The encoded data is output to the transmitter 52, where it is used by a modulator 72 to modulate a carrier signal that is at a desired transmit frequency. Power amplifier circuitry 74 amplifies the modulated carrier signal to a level appropriate for transmission, and delivers the amplified and modulated carrier signal to the antenna 54 through the duplexer or switch 56. The control system 60 will operate to provide the functions described above that embody the concepts of the invention. The control system 60 may be integrated or distributed among different processing circuitry and include the functionality of the baseband processor 58 and other functions of the mobile terminal 12.

As noted above, the mobile terminal 12 may be able to communicate with the wireless access points 20 as well as with the cellular network 24. Accordingly, the receiver front end 50, baseband processor 58, and radio frequency transmitter section 52 cooperate to provide either a wireless interface for the cellular network 24 or the local wireless interface for the wireless access points 20. These functions may be implemented using redundant circuitry, or by configuring common circuitry to operate in different modes. The configuration of the mobile terminal 12 will be dictated by economics and designer choice.

A user may interact with the mobile terminal 12 via the interface 64, which may include interface circuitry 76 associated with a microphone 78, a speaker 80, a keypad 82, and a display 84. The interface circuitry 76 typically includes analog-to-digital converters, digital-to-analog converters, amplifiers, and the like. Additionally, it may include a voice encoder/decoder, in which case it may communicate directly with the baseband processor 58. The microphone 78 will typically convert audio input, such as the user's voice, into an electrical signal, which is then digitized and passed directly or indirectly to the baseband processor 58. Audio information encoded in the received signal is recovered by the baseband processor 58, and converted by the interface circuitry 76 into an analog signal suitable for driving the speaker 80. The keypad 82 and display 84 enable the user to interact with the mobile terminal 12, input numbers to be dialed; access and select addresses, dialing plans, and originating party IDs; select from a number of available networks to use for communications; as well as provide traditional control of the mobile terminal 12.

In addition to or in lieu of the local wireless and cellular interfaces, the mobile terminal 12 may have other communication interfaces, such as a LAN interface 86, to facilitate wired communications. The LAN interface 86 may be configured to connect directly to the LAN 14 or to the docking station 16 via a docking interface 88. When the docking interface 88 is used, the mobile terminal can connect to the docking interface 40 of the docking station 16 wherein a connection to the LAN 14 is provided. As noted, the docking interface 40 can provide power to the mobile terminal 12 as well as a mechanism to exchange instructions and other information between the docking station 16 and the mobile terminal 12.

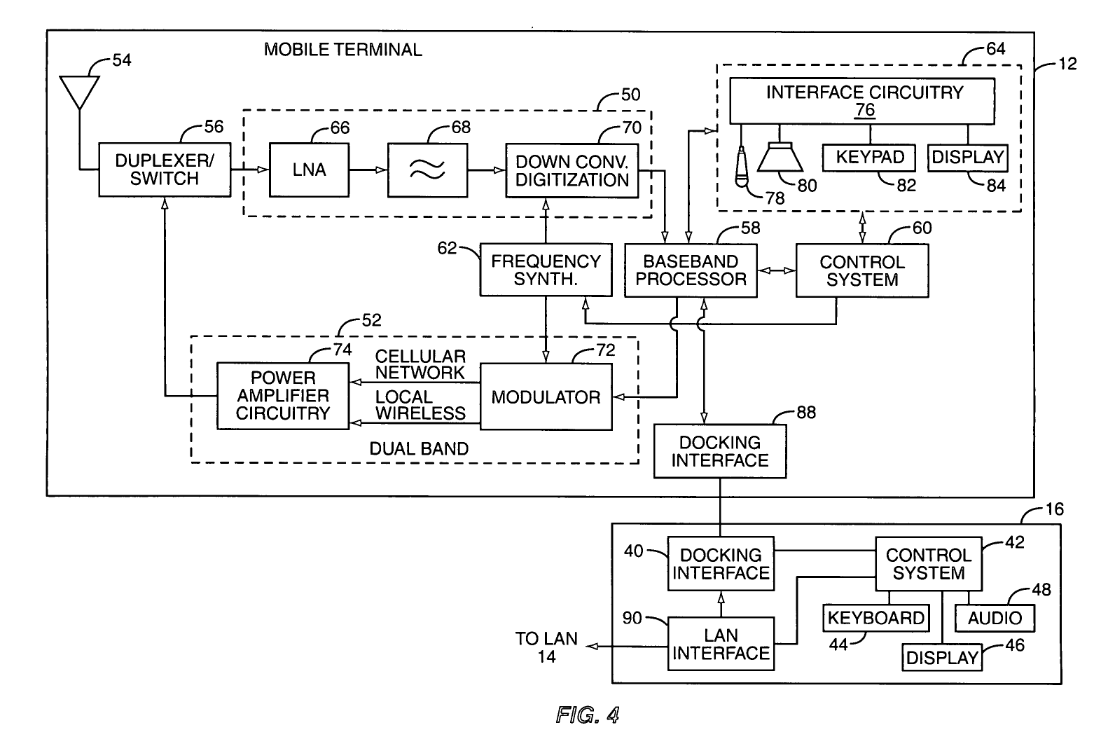

An alternative embodiment of the mobile terminal 12 and docking station 16 is illustrated in FIG. 4. In particular, the mobile terminal 12 does not include the LAN interface 86. Instead, the docking interface 88 cooperates with the baseband processor 58 and control system 60 to direct communications intended for the LAN 14 through the docking interface 88. The docking interface 88 can take many forms, such as a serial or parallel port, USB port or Firewire port. The docking station 16 in this case takes the form of a personal computer with the docking interface 40, such as a USB interface, the control system 42 with associated standard peripherals such as the audio interface 48, display 46 and keyboard 44, and will also include a LAN interface 90 to provide the necessary signal processing to facilitate communications over the LAN 14 or other network through a wired connection. The LAN interface 90 may provide an Ethernet-based interface.

For additional information pertaining to multimode terminals and associated communications, please see U.S. application Ser. No. 10/409,280 filed Apr. 8, 2003 entitled INTEGRATED WIRELINE AND WIRELESS SERVICE, U.S. application Ser. No. 10/409,290 filed Apr. 8, 2003 entitled CALL TRANSFER FOR AN INTEGRATED WIRELINE AND WIRELESS SERVICE; U.S. application Ser. No. 10/693,540 filed Oct. 24, 2003 entitled CALL TRANSFER FOR AN INTEGRATED WIRELINE AND WIRELESS SERVICE USING A TEMPORARY DIRECTORY NUMBER; U.S. application Ser. No. 10/693,539 filed Oct. 24, 2003 entitled CALL TRANSFER FOR AN INTEGRATED WIRELINE AND WIRELESS SERVICE USING A TEMPORARY DIRECTORY NUMBER; and U.S. application Ser. No. 10/784,743 filed Feb. 23, 2004 entitled CALL TRANSFER FOR AN INTEGRATED WIRELINE AND WIRELESS SERVICE, the disclosures of which are incorporated herein by reference in their entireties.

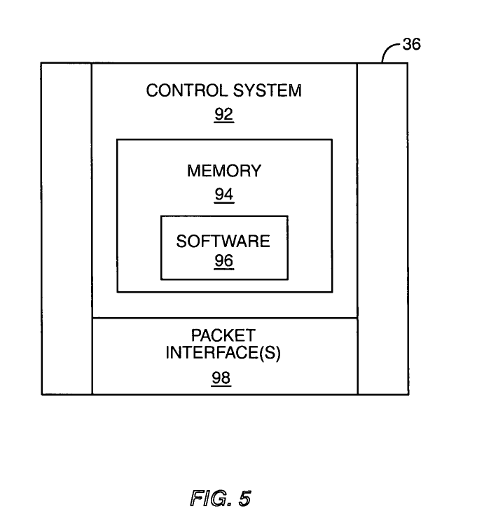

Turning now to FIG. 5, a block representation of a service node 36 is illustrated according to one embodiment of the present invention. The service node 36 will include a control system 92 having memory 94 sufficient for storing software 96 providing the functionality of the service node 36. The control system 92 will also be associated with one or more packet interfaces 98 to facilitate communications with the mobile terminal 12 via the wired and local wireless networks, as well as other packet-based entities. In other embodiments, the mobile terminal 12 may be able to communicate with the service node 36 via the cellular network 24.

Those skilled in the art will recognize improvements and modifications to the preferred embodiments of the present invention. All such improvements and modifications are considered within the scope of the concepts disclosed herein and the claims that follow.

1. A mobile terminal comprising:
a) a first interface adapted to facilitate communications via a wired connection to a first communication network;
b) a second interface adapted to facilitate local wireless communications via a second communication network; and
c) a control system operatively associated with the first and second interfaces and adapted to:
i) establish communication sessions over the first and second communication networks via the first and second interfaces; and
ii) select the first interface for establishing the communication sessions over the first communication network, when the wired connection via the first interface is available.

2. The mobile terminal of claim 1 wherein the control system is further adapted to determine if the wired connection via the first interface is available.

3. The mobile terminal of claim 1 wherein communications via the first interface are associated with a first address and communications via the second interface are associated with a second address.

4. The mobile terminal of claim 3 wherein the control system is further adapted to register with a service node in association with the first address when the wired connection via the first communication interface is available.

5. The mobile terminal of claim 4 wherein the control system is further adapted to register with the service node in association with the second address when the wired connection via the first interface is not available.

6. The mobile terminal of claim 4 wherein the control system is further adapted to register with the service node in association with the second address prior to the wired connection via the first interface becoming unavailable.

7. The mobile terminal of claim 4 wherein the control system is further adapted to register with the service node in association with the second address prior to initiating local wireless communications via the second interface.

8. The mobile terminal of claim 3 wherein the control system is further adapted to obtain the first address after detecting an ability to communicate via the first communication interface, and obtain the second address after detecting an ability to communicate via the second communication interface.

9. The mobile terminal of claim 1 wherein the first communication interface is a docking interface adapted to couple to a docking station, which connects to the first communication network such that the wired connection is facilitated through the docking station.

10. The mobile terminal of claim 9 wherein the first communication interface further comprises a network interface coupled to the docking interface.

11. The mobile terminal of claim 9 wherein the docking station comprises a network interface.

12. The mobile terminal of claim 1 wherein the control system is further adapted to:
a) establish a first session for a communication with an entity via the first interface, the first session identified with first indicia associated with the communication;
b) determine communications via the first interface will no longer be possible; and
c) initiate and establish a second session for the communication with the entity via the second interface, the second session identified with the first indicia.

13. The mobile terminal of claim 12 wherein to determine communications via the first interface will no longer be possible, the control system is adapted to detect being removed from a docking station, which is coupled to the first communication network.

14. The mobile terminal of claim 12 wherein to determine communications via the first interface will no longer be possible, the control system is adapted to detect being removed from being directly coupled to the first communication network.

15. The mobile terminal of claim 12 wherein to determine communications via the first interface will no longer be possible, the control system is adapted to detect a signal sent from a docking station, which is coupled to the first communication network and coupled to the mobile terminal.

16. The mobile terminal of claim 12 wherein the control system is further adapted to:
a) determine communications via the first interface are available; and
b) initiate and establish a third session for the communication with the entity via the first interface, the third session for the communication identified with the first indicia.

17. The mobile terminal of claim 12 wherein the first session is associated with a first address for the mobile terminal and the second session is associated with a second address for the mobile terminal.

18. The mobile terminal of claim 1 further comprising a cellular interface operatively associated with the control system to facilitate cellular communications.

19. A method comprising:
a) providing a first interface adapted to facilitate communications via a wired connection to a first communication network;
b) providing a second interface adapted to facilitate local wireless communications via a second communication network;
c) establishing communication sessions over the first and second communication networks via the first and second network interfaces; and
d) selecting the first interface for establishing the communication sessions over the first communication network, when the wired connection via the first interface is available.

20. The method of claim 19 further comprising determining the wired connection via the first interface is available.

21. The method of claim 19 wherein communications via the first interface are associated with a first address and communications via the second interface are associated with a second address.

22. The method of claim 21 further comprising registering with a service node in association with the first address when the wired connection via the first communication interface is available.

23. The method of claim 22 further comprising registering with the service node in association with the second address when the wired connection via the first interface is not available.

24. The method of claim 22 further comprising registering with the service node in association with the second address prior to the wired connection via the first interface becoming unavailable.

25. The method of claim 22 further comprising registering with the service node in association with the second address prior to initiating local wireless communications via the second interface.

26. The method of claim 21 further comprising obtaining the first address after detecting an ability to communicate via the first communication interface, and obtaining the second address after detecting an ability to communicate via the second communication interface.

27. The method of claim 19 wherein the first communication interface is a docking interface adapted to couple to a docking station, which connects to the first communication network such that the wired connection is facilitated through the docking station.

28. The method of claim 27 further comprising providing a network interface coupled to the docking interface.

29. The method of claim 27 wherein the docking station comprises a network interface.

30. The method of claim 19 further comprising:
a) establishing a first session for a communication with an entity via the first interface, the first session identified with first indicia associated with the communication;
b) determining communications via the first interface will no longer be possible; and
c) initiating and establishing a second session for the communication with the entity via the second interface, the second session identified with the first indicia.

31. The method of claim 30 wherein the step of determining communications via the first interface will no longer be possible comprises detecting being removed from a docking station, which is coupled to the first communication network.

32. The method of claim 30 wherein the step of determining communications via the first interface will no longer be possible comprises detecting being removed from being directly coupled to the first communication network.

33. The method of claim 30 wherein the step of determining communications via the first interface will no longer be possible further comprises detecting a signal sent from a docking station, which is coupled to the first communication network.

34. The method of claim 30 further comprising:
a) determining communications via the first interface are available; and
b) initiating and establishing a third session for the communication with the entity via the first interface, the third session for the communication identified with the first indicia.

35. The method of claim 30 wherein the first session is associated with a first address for the mobile terminal and the second session is associated with a second address fro the mobile terminal.

36. The method of claim 19 further comprising providing a cellular interface to facilitate cellular communications.
